(19) United States
(12) Patent Application Publication
(10) Pub. No.: US 2026/0341287 A1
(43) Pub. Date: Oct. 29, 2026

(54) CODING METHOD, CODING APPARATUS, DECODING METHOD, DECODING APPARATUS, AND TRANSMISSION SYSTEM

(71) Applicant: Beijing Zitiao Network Technology Co., Ltd., Beijing (CN)

(72) Inventors: Jiawei JIANG, Beijing (CN); Dejun ZHANG, Beijing (CN); He WANG, Beijing (CN); Ziqian WU, Beijing (CN); Kunpeng LIN, Beijing (CN); Yijian XIAO, Beijing (CN)

(21) Appl. No.: 19/720,323

(22) Filed: Jun. 25, 2026

Related U.S. Application Data
(63) Continuation of application No. PCT/CN2024/143055, filed on Dec. 27, 2024.

(30) Foreign Application Priority Data
Dec. 29, 2023 (CN) 202311861467.0

(51) Int. Cl. G10L 19/02; G10L 19/038

(52) U.S. Cl. CPC G10L 19/0212; G10L 19/038

(57) ABSTRACT

The present disclosure relates to a coding method, a coding apparatus, a decoding method, a decoding apparatus, and a transmission system, and relates to the technical field of audio processing. The coding method includes: coding current frame audio information to generate main frame data; generating historical frame data, where the historical frame data includes historical frame audio information, and a coding bit rate of the historical frame data is lower than a coding bit rate of the main frame data; and generating a current frame bitstream according to the main frame data and the historical frame data.

### CROSS-REFERENCE TO RELATED APPLICATIONS

The present application is a continuation of International Patent Application No. PCT/CN2024/143055 filed on Dec. 27, 2024, which is based on and claims priority of China Application No. 202311861467.0, filed on Dec. 29, 2023, the disclosures of which are incorporated by reference herein in their entireties.

### TECHNICAL FIELD

The present disclosure relates to the technical field of audio processing, and in particular, to a coding method, a coding apparatus, a decoding method, a decoding apparatus, a transmission system, and a non-transitory computer-readable storage medium.

### BACKGROUND

There are many music scenarios in interactive entertainment applications, such as co-streaming, competitions, or KTV (Karaoke TV) waiting. In music scenarios, users generally have high requirements for audio quality. Even in a weak network scenario, users expect to obtain a smooth music experience. This requires that an audio coding technology used should have a high packet loss resistance.

In related arts, in an RTC (Real-Time Communication) music scenario, a basic PLC (Packet Loss Concealment) algorithm in an Opus music coding mode is used as a packet loss resistant technology.

### SUMMARY

According to some embodiments of the present disclosure, a coding method is provided, including: coding current frame audio information to generate main frame data; generating historical frame data, where the historical frame data includes historical frame audio information, and a coding bit rate of the historical frame data is lower than a coding bit rate of the main frame data; and generating a current frame bitstream according to the main frame data and the historical frame data.

According to other embodiments of the present disclosure, a decoding method is provided, including: receiving a current frame bitstream, where historical frame data of the current frame bitstream is generated by coding historical frame audio information, and main frame data of the current frame bitstream is generated by coding current frame audio information; and in response to a packet loss occurring in the historical frame audio information, decoding the historical frame data to restore the historical frame audio information.

According to still some embodiments of the present disclosure, a coding apparatus is provided, including: a first coding unit, which is configured to code current frame audio information to generate main frame data; a second coding unit, which is configured to generate historical frame data, where the historical frame data includes historical frame audio information, and a coding bit rate of the historical frame data is lower than a coding bit rate of the main frame data; and a generation unit, which is configured to generate a current frame bitstream according to the main frame data and the historical frame data.

According to yet some embodiments of the present disclosure, a decoding apparatus is provided, including: a receiving unit, which is configured to receive a current frame bitstream, where historical frame data of the current frame bitstream is generated by coding historical frame audio information, and main frame data of the current frame bitstream is generated by coding current frame audio information; and a decoding unit, which is configured to, in response to a packet loss occurring in the historical frame audio information, decode the historical frame data to restore the historical frame audio information.

According to yet some embodiments of the present disclosure, a transmission system is provided, including: a coding apparatus, which is configured to perform the coding method in any one of the above embodiments; and a decoding apparatus, which is configured to perform the decoding method in any one of the above embodiments.

According to yet some embodiments of the present disclosure, an electronic device is provided, including: a memory; and a processor coupled to the memory, where the processor is configured to, based on instructions stored in the memory, perform the coding method or the decoding method in any one of the above embodiments.

According to yet some embodiments of the present disclosure, a non-transitory computer-readable storage medium is provided, where a computer program is stored on the non-transitory computer-readable storage medium, and when the program is executed by a processor, the coding method or the decoding method in any one of the above embodiments is implemented.

### BRIEF DESCRIPTION OF THE DRAWINGS

The drawings, which form a part of the specification, illustrate the embodiments of the present disclosure and, together with the description, serve to explain the principles of the present disclosure.

The present disclosure can be more clearly understood according to the following detailed description with reference to the drawings:

FIG. 1 illustrates a flowchart of some embodiments of a coding method of the present disclosure;

FIGS. 2a to 2c illustrate schematic diagrams of some embodiments of an audio data packet of the present disclosure;

FIG. 3a illustrates a schematic diagram of some embodiments of a coding method of the present disclosure;

FIG. 3b illustrates a schematic diagram of some embodiments of a BWE coding method of the present disclosure;

FIG. 4 illustrates a flowchart of some embodiments of a decoding method of the present disclosure;

FIG. 5 illustrates a block diagram of some embodiments of a coding apparatus of the present disclosure;

FIG. 6 illustrates a block diagram of some embodiments of a decoding apparatus of the present disclosure;

FIG. 7 illustrates a block diagram of some embodiments of an electronic device of the present disclosure;

FIG. 8 illustrates a block diagram of some other embodiments of an electronic device of the present disclosure; and

FIG. 9 illustrates a block diagram of some embodiments of a transmission system of the present disclosure.

### DETAILED DESCRIPTION

Various exemplary embodiments of the present disclosure will now be described in detail with reference to the drawings. It should be noted that the relative arrangements, numerical expressions, and numerical values of the components and steps set forth in these embodiments do not limit the scope of the present disclosure, unless specifically stated otherwise.

At the same time, it should be understood that, for the convenience of description, the dimensions of various parts shown in the drawings are not drawn in an actual proportional relationship.

The following description of at least one exemplary embodiment is actually only illustrative, and in no way constitutes any limitation to the present disclosure and its application or use.

Technologies, methods, and devices known to those of ordinary skill in the related fields may not be discussed in detail, but under appropriate circumstances, the technologies, methods, and devices should be regarded as a part of the specification.

In all examples shown and discussed herein, any specific values should be construed as being only exemplary, rather than limiting. Therefore, other examples of the exemplary embodiments may have different values.

It should be noted that similar reference numerals and letters represent similar items in the following drawings, and therefore, once an item is defined in one drawing, it does not need to be further discussed in subsequent drawings.

The inventors of the present disclosure have found that the above related technologies have the following problems: weak packet loss resistance, resulting in poor audio transmission effects.

In view of this, the present disclosure proposes a coding technical solution, which can improve the packet loss resistance, thereby improving the audio transmission effect.

As mentioned above, in view of the above technical problems, it is necessary to improve a packet loss resistant technology of the encoder. The present disclosure can increase the packet loss resistance of the encoder by implementing an in-band FEC (Frame Error Concealment) technology in audio coding based on CELT (Constrained Energy Lapped Transform). In this way, the characteristics of music signals can be utilized to efficiently code music redundancy, and a better packet loss resistant effect can be achieved under a premise of a same bandwidth.

For example, the technical solution of the present disclosure can be implemented by the following embodiments.

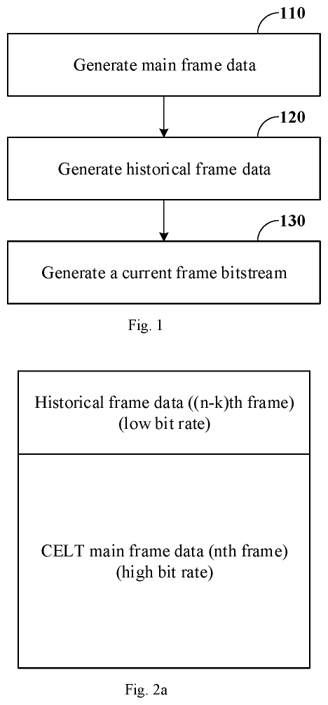

FIG. 1 illustrates a flowchart of some embodiments of a coding method of the present disclosure.

As shown in FIG. 1, in step 110, current frame audio information is coded to generate main frame data. For example, a CELT coding framework may be used to code the current frame audio information to generate the main frame data.

For example, through CELT coding, psychoacoustic principles can be used to divide a spectrum of audio to be coded into multiple sub-bands (such as 21 sub-bands); and energy and a normalized sub-band spectral shape of each sub-band are quantized. The energy of each sub-band may be preferentially coded, and then the shape of each sub-band may be coded (for example, a PVQ (pyramid vector quantization) coding algorithm may be used). In the case of coding the shape of the sub-band, available coding bits (Bit-alloc) are preferentially allocated to a low frequency band.

In some embodiments, an in-band FEC algorithm may be implemented in the CELT audio coding to improve the packet loss resistance of the CELT audio coding. For example, the above technical solution may be implemented by related embodiments of steps 120 and 130.

In step 120, historical frame data is generated, where the historical frame data includes historical frame audio information, and a coding bit rate of the historical frame data is lower than a coding bit rate of the main frame data. For example, the coding bit rate of the historical frame data (which may be referred to as an in-band frame) may not exceed a preset threshold (such as 24 kbps, etc.).

In some embodiments, the main frame data and the historical frame data adopt a same coding framework. For example, the same coding framework includes the CELT coding framework. For example, the CELT main frame data is coded at a high bit rate, and the FEC historical frame data is coded at a low bit rate and a low complexity with a high quality.

For example, the FEC historical frame data and the main frame data use a same set of algorithm frameworks, and the coding logic in Table 1 below may be adopted.

TABLE 1

| Coding logic | Remarks |
|---|---|
| Sub-band energy of 21 sub-bands is preferentially | Energy coding consumes about 6 kbps, and is the most |
| coded | important part for auditory perception, and thus cannot |
| | be discarded; |
| Remaining bits are used for coding spectral shape | High bit rate coding: each sub-band of audio can be |
| quantization (PVQ) of each sub-band | allocated sufficient coding bits, and CELT coding |
| | quality is good; |
| PVQ bits are preferentially allocated to a low | Low bit rate coding: the high frequency sub-band of the |
| frequency band, and then allocated to a high frequency | audio cannot be allocated sufficient coding bits, high |
| band | frequency band coding quality is poor, and CELT uses |
| | spectral folding during decoding to restore a spectral |
| | hole |

In step 130, a current frame bitstream is generated according to the main frame data and the historical frame data.

In the above embodiments, the historical frame data is added to the current frame bitstream, so that the current frame bitstream can carry the historical frame audio information. In this way, the packet loss problem of the historical frame audio information can be effectively coped with, to improve the packet loss resistance, thereby improving the audio transmission effect.

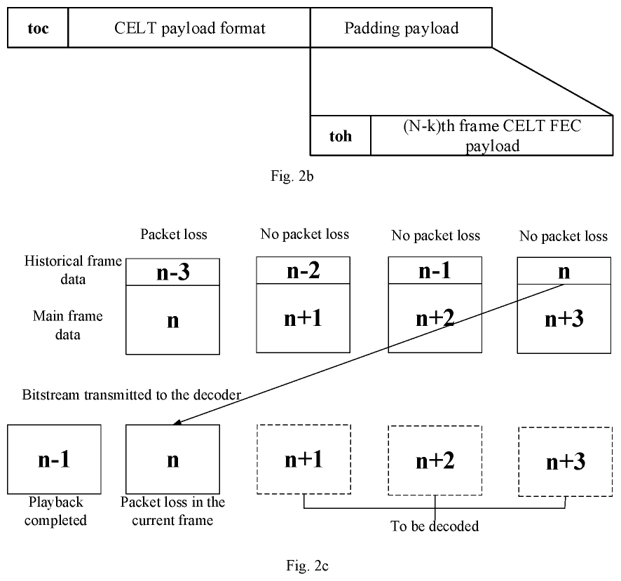

For example, the current frame bitstream may be generated by the embodiments in FIGS. 2a to 2c to implement the above technical solution.

FIGS. 2a to 2c illustrate schematic diagrams of some embodiments of an audio data packet of the present disclosure.

As shown in FIG. 2a, in a data packet of a current frame (such as an nth frame) in which audio coding is performed using CELT, in addition to carrying audio information of the current frame, audio information of a historical frame (such as an (n-k)th frame) is also carried, so as to implement an in-band FEC algorithm in the CELT audio coding.

For example, the coding bit rate of the historical frame data is lower than the coding bit rate of the main frame data. The implementation of the in-band FEC algorithm in the CELT audio coding may satisfy: the historical frame data with a low coding bit rate, such as a coding bit rate of FEC not exceeding 24 kbps; low-complexity coding, such as an increase in coding complexity not exceeding a threshold, such as 25%, after the historical frame data is added; and high-quality audio, such as an increase in MOS (Mean Opinion Score) exceeding a threshold, such as 1.0, in a packet loss scenario.

In some embodiments, the historical frame data includes a bitstream header byte, which is configured to indicate time offset information of the historical frame audio information relative to the current frame audio information.

As shown in FIG. 2b, the current frame bitstream may include a toc field, a CELT payload format field, and a padding payload field. The toc field (belonging to the bitstream header byte) and the CELT payload format field constitute the main frame data, which is configured to store a coding result of the current frame audio information.

The padding payload field includes a toh field and an (n-k)th frame CELT FEC payload field, which are configured to store a coding result of the historical frame audio information. The (n-k)th frame CELT FEC payload field is an in-band FEC field of the (n-k)th frame CELT. The toh field (which may occupy, for example, 1 byte) may be configured to store information about an offset between the historical frame and the current frame, such as k frames; and the (n-k)th frame CELT FEC payload field may be configured to store a coding result of the audio information of the (n-k)th frame.

In some embodiments, the historical frame data is configured to restore the historical frame audio information in response to a packet loss occurring in the historical frame audio information.

For example, in response to a decoder receiving an nth frame data packet, in addition to obtaining audio information of the nth frame by decoding, audio information of an (n-k)th frame can also be obtained by decoding.

In this way, in response to a packet loss occurring in an audio signal of the (n-k)th frame, the audio signal of the (n-k)th frame can be restored with the historical frame data of the nth frame data packet, to improve the packet loss resistance in an audio transmission process, thereby improving the reliability of audio transmission.

As shown in FIG. 2c, four data packets in a first row are data packets of an nth frame to an (n+3)th frame, which respectively include historical frame data configured to store audio information of a historical frame whose offset from a current frame is 3 frames. In a process of transmitting the data packets to the decoder, a packet loss occurs in the data packet of the nth frame, and no packet loss occurs in data packets of remaining four frames.

After playing audio information of an (n−1)th frame, in a case where the decoder side needs to decode the data packet of the nth frame (data packets of the (n+1)th, (n+2)th, and (n+3)th frames are to be decoded), the decoder detects that a packet loss occurs in the data packet of the nth frame; in the above case, the historical frame data of the received data packet of the (n+3)th frame may be decoded to restore the audio information of the nth frame.

In the above embodiments, the historical frame data is generated by coding the historical frame audio information, which can achieve high-quality restoration of audio in the case of a packet loss, thereby enhancing the transmission reliability in audio scenarios such as RTC.

In some embodiments, the historical frame audio information includes high frequency band information and low frequency band information, and a frequency of the high frequency band information is higher than a frequency of the low frequency band information. For example, the frequency of the high frequency band information is higher than a frequency threshold, and the frequency of the low frequency band information is lower than the frequency threshold, e.g., the frequency threshold may be 8 kHz.

In some embodiments, the historical frame data disables spectral shape coding of the high frequency band information. For example, spectral shape information of the high frequency band information is not coded in the historical frame data.

In some embodiments, in response to remaining bits of the historical frame data being below a threshold, the historical frame data disables the spectral shape coding of the high frequency band information, where the remaining bits are a difference between available coding bits and used coding bits.

For example, the remaining bits are bits remaining in the historical frame data after spectral energy coding is performed on the historical frame audio information and spectral shape coding is performed on the low frequency band information. For example, the historical frame data includes the spectral energy information of the historical frame audio information and the spectral shape information of the low frequency band information.

For example, the FEC historical frame data uses a low bit rate coding method and the CELT coding framework. The historical frame data preferentially ensures energy coding quality of each sub-band and spectral shape coding quality of the low frequency band, and reduces the coding bit rate, thereby improving the coding effect. For example, allocation logic of PVQ (Pyramid Vector Quantization) bits of the FEC historical frame data may be changed, and PVQ bit allocation of the high frequency band information is disabled.

In this way, the PVQ coding bit rate can be reduced, thereby improving the coding effect.

In some embodiments, the remaining bits are used for at least one of normalized spectral shape vector quantization, frequency band energy fine quantization, anti-spectral collapse or energy residual quantization of the historical frame data. For example, frequency band energy fine quantization, energy residual quantization, or the like of the FEC historical frame data may be adapted.

For example, the remaining bits of the FEC historical frame data are mainly used for PVQ in normalized spectral band of the FEC historical frame data, historical frame data energy fine quantization, historical frame data anti-spectral collapse, and historical frame data energy residual quantization processing.

For example, the PVQ of the historical frame data preferentially ensures bit allocation of the low frequency band; and in response to bit allocation of the high frequency band being insufficient, the PVQ bit allocation of the high frequency band is disabled.

In some embodiments, the historical frame data includes skip information, which is configured to indicate that the spectral shape coding of the high frequency band information is disabled. For example, for the high frequency band with insufficient bit allocation, by coding SKIP information, PVQ of this high frequency band is skipped.

In some embodiments, a number of available bits of the historical frame data are determined according to the coding bit rate of the historical frame data and a number of bits required for the spectral energy information of the low frequency band information, and the number of available bits of the historical frame data are less than the number of available bits of the main frame data.

For example, the main frame data uses a high bit rate coding method, and the number of available bits (nbCompressedBytes) is a relatively large value; the historical frame data uses a low bit rate coding method, and the number of available bits (nbCompressedBytes_fec) of the FEC historical frame data obtained by calculation using the bit rate control logic of the in-band FEC is a relatively small value. The calculation of the number of available bits of the historical frame data needs to consider the coding bit rate of the FEC historical frame data and the number of PVQ bits required for CELT low frequency band coding.

In some embodiments, a spectral shape of the high frequency band information of the historical frame audio information is restored by using spectral folding or noise padding.

For example, in response to the historical frame data skipping spectral shape coding of the high frequency band of the historical frame audio information through the SKIP information, if the decoding side wants to restore the spectral shape of the high frequency band of the historical frame audio information, the spectral shape of the high frequency band may be restored by using the spectral folding or the noise padding.

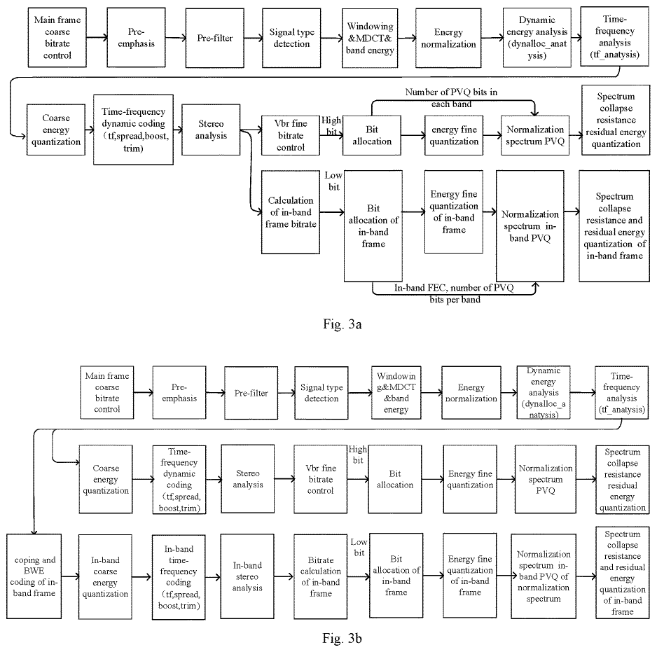

FIG. 3a illustrates a schematic diagram of some embodiments of a coding method of the present disclosure.

As shown in FIG. 3a, under the CELT coding framework, after stereo analysis processing is performed, the historical frame data is generated through steps such as historical frame data bit rate calculation, historical frame data bit allocation, historical frame data energy fine quantization, normalized spectral band PVQ, and historical frame data anti-spectral collapse and energy residual quantization.

In a historical frame data bit rate calculation process, the main frame data uses a high bit rate coding method, and the number of available bits (nbCompressedBytes) is a relatively large values; the historical frame data uses a low bit rate coding method, and the number of available bits (nbCompressedBytes_fec) of the FEC historical frame data obtained by calculation using the bit rate control logic of the in-band FEC is a relatively small values. The calculation of the number of available bits of the historical frame data needs to consider the coding bit rate of the FEC historical frame data and the number of PVQ bits required for CELT low frequency band coding.

In a historical frame data bit allocation process, the remaining bits of the FEC historical frame data are mainly used for PVQ in the normalized spectral band of the FEC historical frame data, historical frame data energy fine quantization, historical frame data anti-spectral collapse, and historical frame data energy residual quantization processing. The PVQ of the historical frame data preferentially ensures bit allocation of the low frequency band; and in response to bit allocation of the high frequency band being insufficient, the PVQ bit allocation of the high frequency band is disabled.

In the normalized spectral band PVQ process, for the high frequency band with insufficient bit allocation, the PVQ of this high frequency band is skipped by coding Skip information.

In some embodiments, symbols in the historical frame data may be configured by the embodiments in Table 2.

TABLE 2

| Symbol | Meaning of the symbol | Remarks |
|---|---|---|
| silence | Whether it is mute | The coding technology is the same as |
| post-filter | Whether a post-filter is enabled | that of the main frame data, and in-band |
| octave | pitch (fundamental tone) period parameter 1 | FEC coding information may be |
| period | pitch period parameter 2 | slightly different |
| gain | pitch gain | |
| tapset | 5-tap filter coefficient | |
| transient | Whether it is a transient frame | |
| intra | Intra prediction mode | |
| | intra = 0, performing inter prediction and intra | |
| | prediction; | |
| | intra = 1, performing only intra prediction; | |
| coarse energy | Coarse energy | |
| tf_change | Deciding time-frequency resolution (tf_res) of | |
| tf_select | each Bin | |
| | Steady-state signal, improving frequency | |
| | resolution | |
| | Transient signal, improving time resolution | |
| spread | Scattering coefficient | |
| dyn. alloc. | Dynamic analysis (frequency domain masking | |
| | model) | |
| | Calculating auditory importance of a frequency | |
| | band and a number of bits of boost | |
| | Corresponding to a “Band Boost” technology in | |
| | bit rate allocation | |
| alloc. trim | Dynamic bit allocation | The coding technology is the same as |
| | Corresponding to an “Allocation trim” | that of the main frame data, and the in- |
| | technology in bit rate allocation | band FEC coding information may be |
| | | slightly different (which may be |
| | | recalculated according to an in-band |
| | | FEC bit rate) |
| skip | Skipping high frequency band PVQ with fewer | The coding technology is the same as |
| | allocable bits | that of the main frame data, and the in- |
| | | band FEC needs to be recalculated and |
| | | coded, and a high frequency band with |
| | | fewer allocated bits is skipped |
| intensity | Dedicated to stereo, >=intensity, and “side” | The coding technology is the same as |
| | information is not coded; | that of the main frame data, and the in- |
| | | band FEC needs to be recalculated and |
| | | coded, an in-band FEC bit rate is |
| | | agreed, and coding may not be |
| | | performed (if in-band FEC = 32 kbps, |
| | | intensity = 10, and if in-band FEC = 24 |
| | | kbps, intensity = 9) |
| dual | Dedicated to stereo, MS or dual | The coding technology is the same as |
| | | that of the main frame data, and the in- |
| | | band FEC coding information may be |
| | | slightly different (which may be |
| | | recalculated according to an in-band |
| | | FEC bit rate) |
| fine energy | Energy fine quantization | The coding technology is the same as |
| | | that of the main frame data, and the in- |
| | | band FEC needs to be recalculated and |
| | | coded |
| residual | PVQ part, codebook search is a main reason for | The coding technology is the same as |
| (Remaining bits) | calculation amount consumption, and in a case | that of the main frame data, and the in- |
| | of different allocated bits, there is an | band FEC needs to be recalculated and |
| | optimization space for the calculation amount in | coded, which may be calculated in |
| | the codebook search process | combination with the main frame data |
| | | to simplify the calculation amount; |
| anti-collapse | Anti-spectral collapse identification | The coding technology is the same as |
| | | that of the main frame data, and the in- |
| | | band FEC needs to be recalculated and |
| | | coded |
| finalize | Energy residual quantization | The coding technology is the same as |
| | | that of the main frame data, and the in- |
| | | band FEC needs to be recalculated and |
| | | coded |

In some embodiments, at least a part of the high frequency band information of the historical frame audio information in the historical frame data is coded using a BWE (bandwidth extension) algorithm. For example, the BWE bitstream information is configured to code the spectral shape of the high frequency band information.

In some embodiments, the BWE bitstream information is configured to code at least one of the spectral energy of the high frequency band information or the bit allocation information of the high frequency band information.

For example, in the case of coding high bit rate CELT main frame data, a low bit rate, low complexity, and high-quality coding method may be used to generate an FEC in-band bitstream; and the FEC in-band bitstream includes a BWE bitstream, which is configured to restore audio information of a high frequency band (such as 8 to 20 kHz).

In some embodiments, the historical frame data is coded using CELT. For example, the high frequency band information coded by CELT in the historical frame data is deleted; and the high frequency band information is coded using the BWE algorithm to generate the BWE bitstream information. For example, the high frequency band information coded by CELT may be replaced with the generated BWE bitstream information.

For example, in the case where the BWE bitstream information is introduced into the FEC historical frame data, the coding information of the high frequency band in the FEC in-band code frame of the original CELT coding framework may be removed.

For example, CELT coding is used for audio information of a low frequency band (such as 0 to 8 kHz). The BWE bitstream information is inserted into an appropriate position of the FEC historical frame data, and the coding information of the high frequency band in the CELT bitstream is removed.

For example, BWE coding is used for audio information of a high frequency band (such as 8 to 20 kHz). The coding method of the FEC historical frame data uses information such as energy of the high frequency band, a spectral shape of the high frequency band, and bit allocation of the high frequency band in the BWE algorithm.

In the above embodiments, a more efficient BWE technology is introduced, and the BWE bitstream information is added to the FEC historical frame data, so that the restoration quality of high frequency band audio information by the FEC historical frame data is improved, thereby improving the transmission reliability and processing effect of the audio information.

In some embodiments, the introduction of the BWE technology may be implemented by the embodiments in FIG. 3b.

FIG. 3b illustrates a schematic diagram of some embodiments of a BWE coding method of the present disclosure.

As shown in FIG. 3b, under the CELT coding framework, after time-frequency analysis processing is performed, the historical frame data is generated through steps such as historical frame data copying and BWE coding, historical frame data energy coarse quantization, in-band time-frequency coding, in-band stereo analysis, historical frame data bit rate calculation, historical frame data bit allocation, historical frame data energy fine quantization, PVQ in normalized spectral band, and historical frame data anti-spectral collapse and energy residual quantization.

In a BWE coding process, the historical frame data may include the BWE state information, which is configured to indicate whether the BWE bitstream information is written in the historical frame data. For example, a BWE_state (configured to indicate whether a BWE state is enabled) field and the BWE bitstream information (information such as the energy of the high frequency band, the spectral shape of the high frequency band, and high frequency band bit allocation) are coded.

For example, in the case of BWE_state=0, the BWE state is disabled, and the coding method in FIG. 3a may be used; and in the case of BWE_state=1, the BWE state is enabled, the BWE bitstream information is written in the historical frame data, and the bitstream information of the high frequency band in FEC in-band coding of the CELT framework is removed.

In some embodiments, the symbols in the historical frame data may be configured by the embodiments in Table 3, to implement the introduction of the BWE technology.

TABLE 3

| Symbol | Meaning of the symbol | Remarks |
|---|---|---|
| silence | Whether it is mute | The coding technology is the same as |
| post-filter | Whether to turn on post-filter | that of the main frame data, and in- |
| octave | Pitch period parameter 1 | band FEC coding information may be |
| period | pitch period parameter 2 | slightly different |
| gain | pitch gain | |
| tapset | 5-tap filter coefficient | |
| transient | Whether it is a transient frame | |
| BWE_state | Whether the current frame needs to be coded into | Unique to FEC historical frame data |
| | BWE | |
| BWE bitstream | BWE_state = 1, then code BWE bitstream | Unique to FEC historical frame data |
| | information | |
| intra | Intra prediction mode | The same coding technology as the |
| | intra = 0, perform inter prediction and intra | main frame data, and in-band FEC |
| | prediction; | needs to be recalculated and recoded |
| | intra = 1, only perform intra prediction | |
| coarse energy | Coarse energy | The same coding technology as the |
| | | main frame data, in-band FEC needs to |
| | | be recalculated and recoded, and if |
| | | BWE is enabled, skip coding of the |
| | | high band |
| tf_change | Decision on time-frequency resolution (tf_res) of | The same coding technology as the |
| tf_select | each Bin | main frame data, in-band FEC needs to |
| | Steady-state signal, improve frequency resolution | be recalculated and recoded, and if |
| | Transient signal, improve time resolution | BWE is enabled, skip coding of the |
| | | high band |
| spread | Scattering coefficient | The same coding technology as the |
| | | main frame data |
| dyn. alloc. | Dynamic analysis (frequency-domain masking | The same coding technology as the |
| | model) Calculate auditory importance of a frequency | main frame data, in-band FEC needs to |
| | band, and a number of boost bits corresponds to | be recalculated and recoded, if BWE is |
| | a “Band Boost” technology in bit rate allocation | enabled, then skip coding of the high |
| | | band |
| alloc. trim | Dynamic bit allocation | The same coding technology as the |
| | Corresponding to an “Allocation trim” | main frame data, and coding |
| | technology in bit rate allocation | information of in-band FEC may be |
| | | slightly different (which may be |
| | | recalculated according to an in-band |
| | | FEC bit rate) |
| skip | Skipping high frequency band PVQ with fewer | The same coding technology as the |
| | allocable bits | main frame data, in-band FEC needs to |
| | | be recalculated and recoded, and if |
| | | BWE is enabled, skip bit allocation of |
| | | the high band |
| intensity | Dedicated to stereo, >=intensity, and “side” | The coding technology is the same as |
| | information is not coded; | that of the main frame data, and the in- |
| | | band FEC needs to be recalculated and |
| | | coded, an in-band FEC bit rate is |
| | | agreed, and coding may not be |
| | | performed (if in-band FEC = 32 kbps, |
| | | intensity = 10, and if in-band FEC = 24 |
| | | kbps, intensity = 9) |
| dual | Dedicated to stereo, MS or dual | The same coding technology as the |
| | | main frame data, and coding |
| | | information of in-band FEC may be |
| | | slightly different (which may be |
| | | recalculated according to an in-band |
| | | FEC bit rate) |
| fine energy | Energy fine quantization | The coding technology is the same as |
| | | that of the main frame data, and the in- |
| | | band FEC needs to be recalculated and |
| | | coded |
| residual | PVQ part, codebook search is a main reason for | The same coding technology as the |
| | calculation amount consumption, and in a case of | main frame data, in-band FEC needs to |
| | different allocated bits, there is an optimization | be recalculated and recoded, and may |
| | space for the calculation amount in the codebook | be calculated in combination with the |
| | search process | main frame data to simplify calculation |
| anti-collapse | Anti-spectral collapse identification | The coding technology is the same as |
| | | that of the main frame data, and the in- |
| | | band FEC needs to be recalculated and |
| | | coded |
| finalize | Energy residual quantization | The coding technology is the same as |
| | | that of the main frame data, and the in- |
| | | band FEC needs to be recalculated and |
| | | coded |

In this way, the decoder side may use the bitstream information of the CELT framework to restore the audio information of the low frequency band, and use the BWE bitstream information to restore the audio information of the high frequency band. BWE can implement guided high frequency band spectral restoration, which can improve the audio restoration effect compared with technologies such as spectral folding, thereby improving the reliability of audio transmission and the audio processing effect.

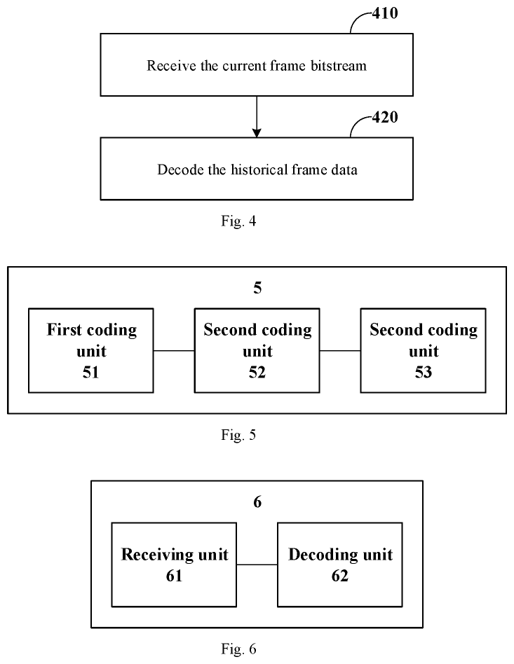

FIG. 4 illustrates a flowchart of some embodiments of a decoding method of the present disclosure.

As shown in FIG. 4, in step 410, a current frame bitstream is received, where historical frame data of the current frame bitstream is generated by coding historical frame audio information, and main frame data of the current frame bitstream is generated by coding current frame audio information.

In step 420, in response to a packet loss occurring in the historical frame audio information, the historical frame data is decoded to restore the historical frame audio information.

In some embodiments, the historical frame audio information includes high frequency band information and low frequency band information, and a frequency of the high frequency band information is higher than a frequency of the low frequency band information; and a number of bits for spectral shape code of the high frequency band information in the historical frame data of the current frame bitstream is less than a number of bits for spectral shape code of high frequency band information in main frame data of a historical frame bitstream.

In some embodiments, a number of bits for spectral shape code of the low frequency band information in the historical frame data of the current frame bitstream is less than or equal to a number of bits for spectral shape code of low frequency band information in the main frame data of the historical frame bitstream.

In some embodiments, the historical frame data disables spectral shape coding of the high frequency band information.

In some embodiments, in response to remaining bits of the historical frame data being below a threshold, the historical frame data disables the spectral shape coding of the high frequency band information, where the remaining bits are a difference between available coding bits and used coding bits.

In some embodiments, the historical frame data includes skip information, which is configured to indicate that the spectral shape coding of the high frequency band information is disabled.

In some embodiments, the historical frame data includes spectral energy information of the historical frame audio information and spectral shape information of the low frequency band information.

In some embodiments, the historical frame data includes a bitstream header byte, which is configured to indicate time offset information of the historical frame audio information relative to the current frame audio information.

In some embodiments, at least a part of the high frequency band information of the historical frame audio information in the historical frame data is coded using a bandwidth extension (BWE) algorithm.

In some embodiments, the historical frame data includes BWE bitstream information, which is configured to code a spectral shape of the high frequency band information.

In some embodiments, the BWE bitstream information is configured to code at least one of spectral energy of the high frequency band information or bit allocation information of the high frequency band information.

In some embodiments, the historical frame data includes BWE state information, which is configured to indicate whether the BWE bitstream information is written in the historical frame data.

In some embodiments, the historical frame data is coded using a constrained energy lapped transform (CELT).

In some embodiments, the historical frame data includes an indication identification, which is configured to indicate whether to perform spectral shape coding on the historical frame audio information.

FIG. 5 illustrates a block diagram of some embodiments of a coding apparatus of the present disclosure.

As shown in FIG. 5, the coding apparatus 5 includes: a first coding unit 51, which is configured to code current frame audio information to generate main frame data; a second coding unit 52, which is configured to generate historical frame data, where the historical frame data includes historical frame audio information, and a coding bit rate of the historical frame data is lower than a coding bit rate of the main frame data; and a generation unit 53, which is configured to generate a current frame bitstream according to the main frame data and the historical frame data.

In some embodiments, the historical frame audio information includes high frequency band information and low frequency band information, and a frequency of the high frequency band information is higher than a frequency of the low frequency band information; and a number of bits for spectral shape code of the high frequency band information in the historical frame data of the current frame bitstream is less than a number of bits for spectral shape code of high frequency band information in main frame data of a historical frame bitstream.

In some embodiments, a number of bits for spectral shape code of the low frequency band information in the historical frame data of the current frame bitstream is less than or equal to a number of bits for spectral shape code of low frequency band information in the main frame data of the historical frame bitstream.

In some embodiments, the historical frame data disables spectral shape coding of the high frequency band information.

In some embodiments, in response to remaining bits of the historical frame data being below a threshold, the historical frame data disables the spectral shape coding of the high frequency band information, where the remaining bits are a difference between available coding bits and used coding bits.

In some embodiments, the historical frame data includes skip information, which is configured to indicate that the spectral shape coding of the high frequency band information is disabled.

In some embodiments, the historical frame data includes spectral energy information of the historical frame audio information and spectral shape information of the low frequency band information.

In some embodiments, the historical frame data includes a bitstream header byte, which is configured to indicate time offset information of the historical frame audio information relative to the current frame audio information.

In some embodiments, at least a part of the high frequency band information of the historical frame audio information in the historical frame data is coded using a bandwidth extension (BWE) algorithm.

In some embodiments, the historical frame data includes BWE bitstream information, which is configured to code a spectral shape of the high frequency band information.

In some embodiments, the BWE bitstream information is configured to code at least one of spectral energy of the high frequency band information or bit allocation information of the high frequency band information.

In some embodiments, the historical frame data includes BWE state information, which is configured to indicate whether the BWE bitstream information is written in the historical frame data.

In some embodiments, the historical frame data is coded using a constrained energy lapped transform (CELT).

In some embodiments, the historical frame data includes an indication identification, which is configured to indicate whether to perform spectral shape coding on the historical frame audio information.

FIG. 6 illustrates a block diagram of some embodiments of a decoding apparatus of the present disclosure.

As shown in FIG. 6, the decoding apparatus 6 includes: a receiving unit 61, which is configured to receive a current frame bitstream, where historical frame data of the current frame bitstream is generated by coding historical frame audio information, and main frame data of the current frame bitstream is generated by coding current frame audio information; and a decoding unit 62, which is configured to, in response to a packet loss occurring in the historical frame audio information, decode the historical frame data to restore the historical frame audio information.

In some embodiments, the historical frame audio information includes high frequency band information and low frequency band information, and a frequency of the high frequency band information is higher than a frequency of the low frequency band information; and a number of bits for spectral shape code of the high frequency band information in the historical frame data of the current frame bitstream is less than a number of bits for spectral shape code of high frequency band information in main frame data of a historical frame bitstream.

In some embodiments, a number of bits for spectral shape code of the low frequency band information in the historical frame data of the current frame bitstream is less than or equal to a number of bits for spectral shape code of low frequency band information in the main frame data of the historical frame bitstream.

In some embodiments, the historical frame data disables spectral shape coding of the high frequency band information.

In some embodiments, in response to remaining bits of the historical frame data being below a threshold, the historical frame data disables the spectral shape coding of the high frequency band information, where the remaining bits are a difference between available coding bits and used coding bits.

In some embodiments, the historical frame data includes skip information, which is configured to indicate that the spectral shape coding of the high frequency band information is disabled.

In some embodiments, the historical frame data includes spectral energy information of the historical frame audio information and spectral shape information of the low frequency band information.

In some embodiments, the historical frame data includes a bitstream header byte, which is configured to indicate time offset information of the historical frame audio information relative to the current frame audio information.

In some embodiments, at least a part of the high frequency band information of the historical frame audio information in the historical frame data is coded using a bandwidth extension (BWE) algorithm.

In some embodiments, the historical frame data includes BWE bitstream information, which is configured to code a spectral shape of the high frequency band information.

In some embodiments, the BWE bitstream information is configured to code at least one of spectral energy of the high frequency band information or bit allocation information of the high frequency band information.

In some embodiments, the historical frame data includes BWE state information, which is configured to indicate whether the BWE bitstream information is written in the historical frame data.

In some embodiments, the historical frame data is coded using a constrained energy lapped transform (CELT).

In some embodiments, the historical frame data includes an indication identification, which is configured to indicate whether to perform spectral shape coding on the historical frame audio information.

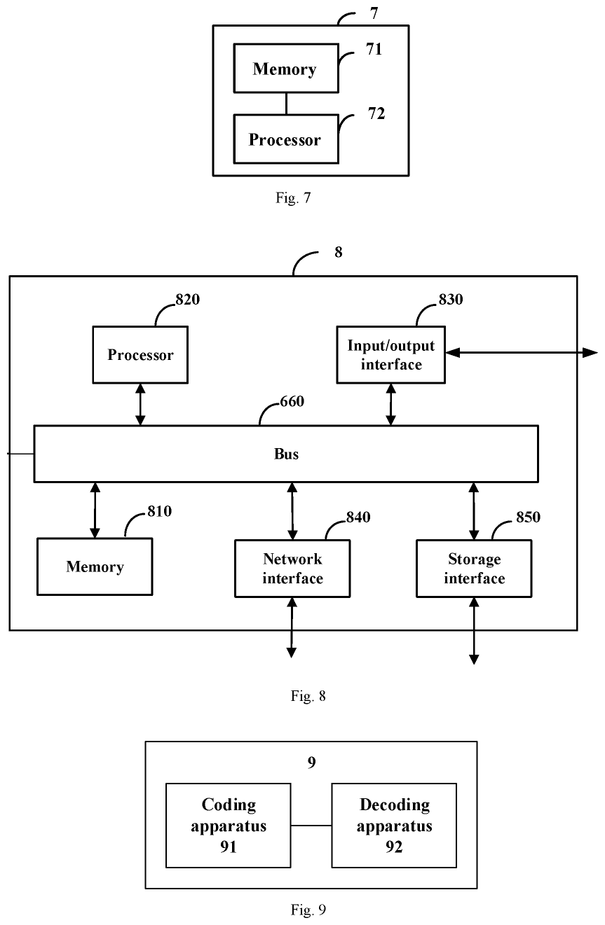

FIG. 7 illustrates a block diagram of some embodiments of an electronic device of the present disclosure.

As shown in FIG. 7, the electronic device 7 in this embodiment includes: a memory 71 and a processor 72 coupled to the memory 71, where the processor 72 is configured to, based on instructions stored in the memory 71, perform the coding method or the decoding method in any one of the embodiments of the present disclosure.

The memory 71 may include, for example, a system memory, a fixed non-volatile storage medium, etc. The system memory stores, for example, an operating system, an application, a boot loader, a database, and other programs.

FIG. 8 illustrates a block diagram of some other embodiments of an electronic device of the present disclosure.

As shown in FIG. 8, the electronic device 8 in this embodiment includes: a memory 810 and a processor 820 coupled to the memory 810, where the processor 820 is configured to, based on instructions stored in the memory 810, perform the coding method or the decoding method in any one of the above embodiments.

The memory 810 may include, for example, a system memory, a fixed non-volatile storage medium, etc. The system memory stores, for example, an operating system, an application, a boot loader, and other programs.

The electronic device 8 may further include an input/output interface 830, a network interface 840, a storage interface 850, etc. These interfaces 830, 840, 850 and the memory 810 and the processor 820 may be connected, for example, through a bus 860. The input/output interface 830 provides a connection interface for input/output devices such as a display, a mouse, a keyboard, a touch screen, a microphone, and a speaker. The network interface 840 provides a connection interface for various networking devices. The storage interface 850 provides a connection interface for an external storage device such as an SD card and a USB flash disk.

FIG. 9 illustrates a block diagram of some embodiments of a transmission system of the present disclosure.

As shown in FIG. 9, the transmission system 9 includes: a coding apparatus 91, which is configured to perform the coding method in any one of the above embodiments; and a decoding apparatus 92, which is configured to perform the decoding method in any one of the above embodiments.

Those skilled in the art should understand that the embodiments of the present disclosure may be provided as a method, a system, or a computer program product. Therefore, the present disclosure may take a form of an entire hardware embodiment, an entire software embodiment, or an embodiment containing both hardware and software elements. Further, the present disclosure may take a form of a computer program product implemented on one or more computer-usable non-transitory storage media having computer-usable program code embodied therein, including but not limited to a disk memory, a CD-ROM, an optical memory, etc.

So far, the coding method, the coding apparatus, the decoding method, the decoding apparatus, the transmission system, and the non-transitory computer-readable storage medium according to the present disclosure have been described in detail. In order to avoid obscuring the concept of the present disclosure, some details known in the art are not described. Those skilled in the art may fully understand how to implement the technical solutions disclosed herein based on the above description.

The method and system of the present disclosure may be implemented in many ways. For example, the method and system of the present disclosure may be implemented by software, hardware, firmware, or any combination of software, hardware, and firmware. The above order of the steps of the method is only for illustration, and the steps of the method of the present disclosure are not limited to the order specifically described above, unless otherwise specifically stated. In addition, in some embodiments, the present disclosure may also be implemented as programs recorded on a recording medium, where these programs include machine-readable instructions for implementing the method according to the present disclosure. Therefore, the present disclosure also covers the recording medium storing the programs for performing the method according to the present disclosure.

Although some specific embodiments of the present disclosure have been described in detail by way of examples, those skilled in the art should understand that the above examples are only for illustration, rather than limiting the scope of the present disclosure. Those skilled in the art should understand that the above embodiments may be modified without departing from the scope and spirit of the present disclosure. The scope of the present disclosure is defined by the appended claims.

What is claimed is:

1. A coding method, comprising:
coding current frame audio information to generate main frame data;
generating historical frame data, wherein the historical frame data comprises historical frame audio information, and a coding bit rate of the historical frame data is lower than a coding bit rate of the main frame data; and
generating a current frame bitstream according to the main frame data and the historical frame data.

2. The coding method of claim 1, wherein:
the historical frame audio information comprises high frequency band information and low frequency band information, and a frequency of the high frequency band information is higher than a frequency of the low frequency band information; and
a number of bits for spectral shape code of the high frequency band information in the historical frame data of the current frame bitstream is less than a number of bits for spectral shape code of high frequency band information in main frame data of a historical frame bitstream.

3. The coding method of claim 2, wherein a number of bits for spectral shape code of the low frequency band information in the historical frame data of the current frame bitstream is less than or equal to a number of bits for spectral shape code of low frequency band information in the main frame data of the historical frame bitstream.

4. The coding method of claim 2, wherein the historical frame data disables spectral shape coding of the high frequency band information.

5. The coding method of claim 4, wherein in response to remaining bits of the historical frame data being below a threshold, the historical frame data disables the spectral shape coding of the high frequency band information, wherein the remaining bits are a difference between available coding bits and used coding bits.

6. The coding method of claim 4, wherein the historical frame data comprises skip information, which is configured to indicate that the spectral shape coding of the high frequency band information is disabled.

7. The coding method of claim 2, wherein the historical frame data comprises spectral energy information of the historical frame audio information and spectral shape information of the low frequency band information.

8. The coding method of claim 1, wherein the historical frame data comprises a bitstream header byte, which is configured to indicate time offset information of the historical frame audio information relative to the current frame audio information.

9. The coding method of claim 1, wherein at least a part of high frequency band information of the historical frame audio information in the historical frame data is coded using a bandwidth extension (BWE) algorithm.

10. The coding method of claim 9, wherein the historical frame data comprises BWE bitstream information, which is configured to code a spectral shape of the high frequency band information.

11. The coding method of claim 10, wherein the BWE bitstream information is configured to code at least one of spectral energy of the high frequency band information or bit allocation information of the high frequency band information.

12. The coding method of claim 10, wherein the historical frame data comprises BWE state information, which is configured to indicate whether the BWE bitstream information is written in the historical frame data.

13. The coding method of claim 1, wherein the historical frame data is coded using a constrained energy lapped transform (CELT).

14. The coding method of claim 1, wherein the historical frame data comprises an indication identification, which is configured to indicate whether to perform spectral shape coding on the historical frame audio information.

15. A decoding method, comprising:
receiving a current frame bitstream, wherein historical frame data of the current frame bitstream is generated by coding historical frame audio information, and main frame data of the current frame bitstream is generated by coding current frame audio information; and
decoding, in response to a packet loss occurring in the historical frame audio information, the historical frame data to restore the historical frame audio information.

16. The decoding method of claim 15, wherein:
the historical frame audio information comprises high frequency band information and low frequency band information, and a frequency of the high frequency band information is higher than a frequency of the low frequency band information; and
a number of bits for spectral shape code of the high frequency band information in the historical frame data of the current frame bitstream is less than a number of bits for spectral shape code of high frequency band information in main frame data of a historical frame bitstream.

17. The decoding method of claim 16, wherein a number of bits for spectral shape code of the low frequency band information in the historical frame data of the current frame bitstream is less than or equal to a number of bits for spectral shape code of low frequency band information in the main frame data of the historical frame bitstream.

18. A transmission system, comprising:
a coding apparatus, which is configured to perform a coding method, comprising:
coding current frame audio information to generate main frame data;
generating historical frame data, wherein the historical frame data comprises historical frame audio information, and a coding bit rate of the historical frame data is lower than a coding bit rate of the main frame data; and
generating a current frame bitstream according to the main frame data and the historical frame data; and
a decoding apparatus, which is configured to perform a decoding method of claim 15.

19. An electronic device, comprising:
a memory; and
a processor coupled to the memory, wherein the processor is configured to, based on instructions stored in the memory, perform a coding method, comprising:
coding current frame audio information to generate main frame data;
generating historical frame data, wherein the historical frame data comprises historical frame audio information, and a coding bit rate of the historical frame data is lower than a coding bit rate of the main frame data; and
generating a current frame bitstream according to the main frame data and the historical frame data, or a decoding method of claim 15.

20. A non-transitory computer-readable storage medium, wherein a computer program is stored on the non-transitory computer-readable storage medium, and when the program is executed by a processor, a coding method, comprising:
coding current frame audio information to generate main frame data;
generating historical frame data, wherein the historical frame data comprises historical frame audio information, and a coding bit rate of the historical frame data is lower than a coding bit rate of the main frame data; and
generating a current frame bitstream according to the main frame data and the historical frame data, or a decoding method of claim 15 is implemented.
